(19) United States
(12) Patent Application Publication
(10) Pub. No.: US 2024/0407308 A1
(43) Pub. Date: Dec. 12, 2024

(54) NON-WOVEN FABRICS FOR AGRICULTURAL PRODUCTS

(71) Applicant: BERRY GLOBAL, INC., Evansville, IN (US)

(72) Inventors: Thomas A. ZIRGEL, Heidolsheim (FR); Didier HUNSINGER, Biesheim (FR); Miriam MALOCHO, Mönchengladbach (DE)

(21) Appl. No.: 18/738,131

(22) Filed: Jun. 10, 2024

Related U.S. Application Data
(60) Provisional application No. 63/472,120, filed on Jun. 9, 2023.

(51) Int. Cl. A01G 13/02; D01F 1/04; D04H 3/005; D04H 3/16

(52) U.S. Cl. CPC A01G 13/0268; D01F 1/04; D04H 3/005; D04H 3/16

(57) ABSTRACT

An agricultural cover is formed from a spunbond material. The non-woven fabric may be used with agricultural products.

### CROSS-REFERENCE TO RELATED APPLICATION

The present disclosure claims priority to and the benefit of U.S. Provisional Application No. 63/472, 120, entitled “Non-Woven Fabrics for Agricultural Products,” filed on Jun. 9, 2023, the content of which is incorporated by reference herein in its entirety.

### BACKGROUND

The present disclosure relates to fabrics, and particularly to fabrics used with agricultural products. More particularly, the present disclosure relates to non-woven fabrics used with agricultural products.

### SUMMARY

According to the present disclosure, one or more non-woven fibers are arranged to form a fleece.

In illustrative embodiments, the fleece can be formed from a spunbond material that includes pellets of a polymer or a copolymer that is configured to cover crops to cause a temperature of the crops covered thereby to be in a range of about 5 degrees Celsius to about 20 degrees Celsius cooler than ambient temperature.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a top perspective view of an embodiment of a fabric suitable for making the fleece of the present disclosure;

FIG. 2A is a perspective view of an example embodiment of the fleece of FIG. 1A used as a row cover for crops disposed next to row covers of comparative horticultural fleeces;

FIG. 2B is a perspective view of another exemplary embodiment of the fleece of FIG. 1A mounted to poles to cover crops that grow raised off the ground disposed next to comparative horticultural fleeces mounted to poles;

FIG. 3A is a top perspective view of a sample of a fleece of the present embodiments having a blue pigment and an infrared masterbatch;

FIG. 3B is a top perspective view of a sample of a comparative fleece having a white pigment and the infrared masterbatch;

FIG. 3C is a top perspective view of a comparative horticultural fleece that lacks both the blue pigment and the infrared masterbatch;

FIG. 4A is a graph illustrating reflectance of the samples of FIGS. 3A-3C during the day;

FIG. 4B is a graph illustrating transmittance of the samples of FIGS. 3A-3C during the day;

FIG. 4C is a graph illustrating absorbance of the samples of FIGS. 3A-3C during the day;

FIG. 4D is a graph illustrating energy given off by the sun and its impact on energy reflected, transmitted, and absorbed by the non-woven;

FIG. 4E is a table illustrating the values for reflectance, transmittance, and absorbance displayed in the graphs of FIGS. 4A-4C with solar energy being integrated, e.g., taken into account;

FIG. 5A is a graph illustrating reflectance of the samples of FIGS. 3A-3C at night;

FIG. 5B is a graph illustrating transmittance of the samples of FIGS. 3A-3C at night;

FIG. 5C is a graph illustrating absorbance of the samples of FIGS. 3A-3C at night;

FIG. 5D is a graph illustrating energy given off by the blackbody and its impact on blackbody energy reflected, transmitted, and absorbed by the non-woven;

FIG. 5E is a table illustrating the values for reflectance, transmittance, and absorbance displayed in the graphs of FIGS. 5A-5C with blackbody energy being integrated, e.g., taken into account;

FIG. 6A is a perspective view illustrate the fleece of FIG. 1 used as a row cover for Caribbean gold melons next to row covers of horticultural fleeces;

FIG. 6B is a graphical illustration of a comparison of number of fruits per 10 linear meters versus size of fruits for the fleece and the horticulture fleece;

FIG. 6C is a graphical illustration of a comparison of high and low ambient temperature over a year period;

FIG. 7A is a perspective view illustrate the fleece of FIG. 1 used as a row cover for Caribbean gold melons next to row covers of horticultural fleeces;

FIG. 7B is a graphical illustration of a comparison of number of fruits per 10 linear meters versus size of fruits for the fleece and the horticulture fleece;

FIG. 7C is a graphical illustration of a comparison of high and low ambient temperatures over a year period;

FIG. 8A is a perspective view illustrate the fleece of FIG. 1 used as a row cover for Tigris watermelon next to row covers of horticultural fleeces;

FIG. 8B is a graphical illustration of a comparison of number of fruits per 10 linear meters versus size of fruits for the fleece and the horticulture fleece;

FIG. 9A is a perspective view illustrate the fleece of FIG. 1 mounted to poles for Pony Express Tomato next to mounted poles of horticultural fleeces;

FIG. 9B is a graphical illustration of a comparison of size of fruits versus number of days for the fleece and the horticulture fleece;

FIG. 9C is a table illustrating results of FIG. 6A;

FIG. 10A is a perspective view illustrate the fleece of FIG. 1 used as a row cover for Magaly Chili Pepper next to row covers of horticultural fleeces;

FIG. 10B is a graphical illustration of a comparison of size of fruits versus number of days for the fleece and the horticulture fleece;

FIG. 10C is a table illustrating results of FIG. 7A;

FIG. 11 is a graphical illustration of ambient temperatures, and temperatures of crops under the fleece of FIG. 1 and under comparative horticultural fleeces; and

FIG. 12 is a graphical illustration of delta of temperature below the fleece of FIG. 1 versus comparative horticultural fleeces.

### DETAILED DESCRIPTION

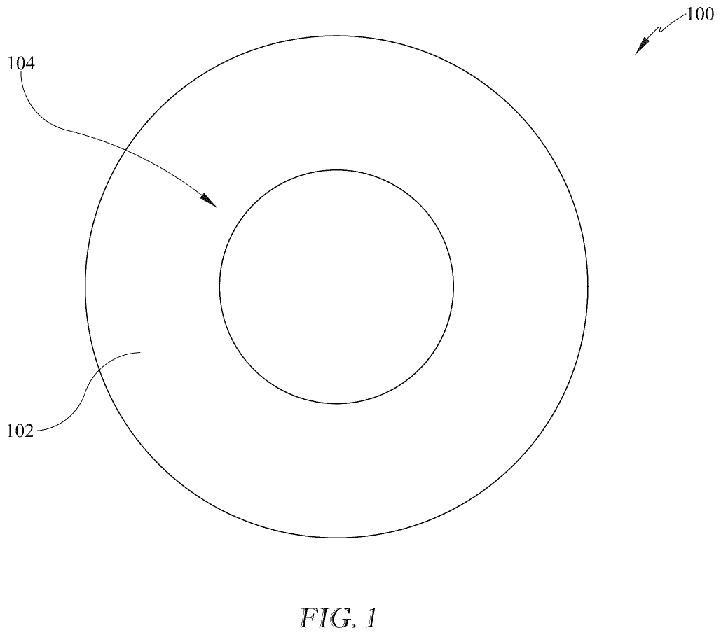

FIG. 1 illustrates an example embodiment of a fleece or fabric 100 that can control temperatures of growing crops from hot temperatures, e.g., during the hot summer months in the Northern hemisphere. It will be appreciated that for the purposes of the present disclosure, the term “fleece” can be used to refer to a crop cover, which can include an agricultural crop cover, which includes a non-woven material sheet formed from that cover. Comparative horticultural fleece can be a thin, non-woven, polypropylene fabric which is used in crop protection. Specifically, horticultural fleece can be used as a floating mulch to protect both late and early crops and delicate plants from cold weather and frost, as well as insect pests during the normal growing season. The fleece can admit light, air, and rain but creates a microclimate around the developing plants, allowing them to grow faster than the unprotected crops. The fleece can be laid across rows of plants as a row cover and secured in place with pegs, soil bags, or other weights while leaving room for the plants to grow underneath the row cover. While comparative horticulture fleeces may be used to control temperatures during cold months to protect crops from cold weather, a solution does not currently exist for protecting crops from hot weather. Hot weather can negatively impact harvest yields and increase stress exhibited by the crops at peak temperatures.

The fleece 100 can lower high peak temperatures below the fleece 100 by avoiding infrared transmission below the fleece 100 to reduce and/or avoid sunburn experienced by the plants, flowers, and/or leaves that are covered by the fleece. For example, a spunbond fleece in accordance with the present disclosure may be configured to provide means for normalizing or limiting variability of temperatures of crops disposed under the spunbond fleece as compared to crops exposed to ambient temperatures to improve one or more of crop size, overall crop yields or output, number of crops harvested, or stress experienced by crops at peak temperatures. For example, in some embodiments, the fleece 100 of the present embodiments can regulate temperature of the underlying crops based on the ambient temperature to which the crops are exposed. Specifically, in embodiments in which the ambient temperature is below 25° C., a temperature of the crops disposed under the spunbond fleece as compared to crops exposed to ambient temperatures and/or the comparative horticultural fleece can remain unchanged. In embodiments in which the ambient temperature is above 25° C./28° C., a temperature of the crops disposed under the spunbond fleece can be lower by approximately a range of about 5 degrees Celsius (° C) to about 20° C., or by approximately a range of about 5° C. to about 10° C., as compared to a comparative horticultural fleece.

Further, covering the plants can also keep a temperature of the plants more stable, e.g., within a narrower range with less variation, between day and night. For example, during the night, when ambient temperatures are typically lower, the temperature of the plants below the fleece 100 can be hotter than below the comparative horticultural fleece, which in combination with the discussion above, works to keep the range of temperatures of the crops within a narrower range throughout the day, e.g., during day and night, leading to less high/low temperature variation. These smaller ranges have been shown to promote better crop growth, as discussed in the Examples below. In some embodiments, the fleece 100 can also be used to keep a stable temperature throughout the night.

In some embodiments, the fleece 100 can be used in combination with a mulch, e.g., black film mulch, among others, to provide enhanced temperature control, as discussed in greater detail below. In some embodiments, the fleece 100 can be a multi-layer fleece, with the fleece 100 having a plurality of layers 104 disposed and/or stacked on one another. The fleece 100 may be used to protect against insect pests.

### Ingredients

The fleece 100 can be composed of one or more fibers or filaments 102 arranged in a random pattern to form the fleece. In the case where the fiber structure of the present disclosure is a non-woven fabric, the kind of non-woven fabric is not limited. The production method is not particularly limited, but it is preferable to use a spunbonding process, a melt-blowing process, a flash-spinning process, a needle-punching process, a hydroentangling process, an air-laying process, a thermal bonding process, a resin bonding process, a wet process, or the like.

For example, in the case of a non-woven fabric, it can be produced by a spunbonding process, in which a molten polymer is extruded through a nozzle and drawn by suction with a high-speed suction gas. The resulting fibers can then be collected on a moving conveyer to form a web, which is successively followed by thermal bonding, entangling, or the like to integrate the fibers into a sheet.

In some embodiments, the fleece 100 can include a polymer or copolymer that forms the fabric thereof. The polymer can be in pellet form. Some non-limiting examples of the polymer can include polyethylene terephthalate, polyethylene naphthalate, polytrimethylene terephthalate, polypropylene naphthalate, polybutylene terephthalate, polybutylene naphthalate, polyethylene(terephthalate/isophthalate), polytrimethylene(terephthalate/isophthalate), polybutylene(terephthalate/isophthalate), polyethylene terephthalate-polyethylene glycol, polytrimethylene terephthalate-polyethylene glycol, polybutylene terephthalate-polyethylene glycol, polybutylene naphthalate-polyethylene glycol, polyethylene terephthalate-poly(tetramethylene oxide) glycol, polytrimethylene terephthalate-poly(tetramethylene oxide) glycol, polybutylene terephthalate-poly(tetramethylene oxide) glycol, polybutylene naphthalate -poly(tetramethylene oxide) glycol, polyethylene(terephthalate/isophthalate) -poly(tetramethylene oxide) glycol, polytrimethylene(terephthalate/isophthalate) -poly(tetramethylene oxide) glycol, polybutylene(terephthalate/isophthalate) -poly(tetramethylene oxide) glycol, polybutylene(terephthalate/succinate), polyethylene(terephthalate/succinate), polybutylene(terephthalate/adipate), and polyethylene(terephthalate/adipate). In some embodiments, the pellets can include polypropylene, polyethylene, raw materials, such as polyhydroxyalkanoates (PHA), poly(lactic acid) (PLA), and/or poly(butylene succinate) (PBS), among others, and/or combinations thereof.

An amount of polymer in the fleece 100 can vary. For example, in some embodiments, the amount of polymer can be approximately in a range of about 50 wt % to about 99.5 wt %, about 60 wt % to about 99 wt %, about 70 wt % to about 98 wt %, about 80 wt % to about 97 wt %, about 90 wt % to about 96 wt %, and/or have a value of about 99wt %, about 98%, about 97%, about 96%, about 95%, and/or about 92%, with the wt % being measured relative to a total weight of the fleece.

The fleece 100 can include a UV stabilizer. Some non-limiting examples of stabilizers can include benzophenone compounds, benzotriazole compounds, aromatic benzoate compounds, oxalic acid anilide compounds, cyanoacrylate compounds, and/or hindered amine compounds. In the case of a hindered amine compound, the UV stabilizer can include a masterbatch with sterically hindered amine. An amount of the UV stabilizer can vary. For example, in some embodiments, the amount of UV stabilizer can be approximately in a range of about 0.1 wt % to about 1 wt %, about 0.3 wt % to about 0.6 wt %, about 0.35 wt % to about 0.55 wt %, about 0.45 wt % to about 5 wt %, and/or have a value of about 0.3 wt %, 0.4 wt %, 0.5 wt %, and/or 0.6 wt %, with the wt % being measured relative to a total weight of the fleece.

The fleece 100 can include a masterbatch that can be used to color the fibers 102 thereof. For example, a coloring composition containing a pigment dispersion and a crosslinking agent is used, the pigment dispersion containing a pigment having an average particle size of 0.1 to 0.5 μm, a polymeric dispersant having a hydrophobic group and an ionic group, and an aqueous medium. The composition is subjected to a crosslinking reaction between the polymeric dispersant and the crosslinking agent at the time of coloring, thereby binding the pigment onto the fiber structure to achieve coloring. A coloring composition having these components dispersed and mixed therein may be used. The pigmentation of the fleece can be varied, as discussed in greater detail below.

Some non-limiting examples of pigments can be phthalocyanine pigments, ultramarine blue, iron blue, and the like as blue pigments. As shown, some non-limiting examples of the color of the blue pigment can include Reflex Blue, and/or PMS 277-303, with specific pigmentation in PMS 286, 293, 2935, and/or any suitable blue pigment having a wavelength between about 400 nm to about 500 nm. An amount of the blue masterbatch in the fleece 100 can vary. For example, in some embodiments, the amount of blue masterbatch can be approximately in a range of about 0.2 wt % to about 10 wt %, about 0.5 wt % to about 5 wt %, about 1 wt % to about 4 wt %, about 1.25 wt % to about 3 wt %, about 1.5 wt % to about 2.5 wt %, and/or have a value of about 2 wt %, with the wt % being measured relative to a total weight of the fleece.

In some embodiments, the pigment of the fleece 100 can be fuchsia. Fuchsia pigments can facilitate improved photosynthesis processes in the crops below. In some embodiments, the fuchsia pigment can be composed of a combination of a red pigment and a blue pigment. It will be appreciated that the red pigment can include any red pigment having a wavelength between about 600 nm to about 700 nm. For example, in some embodiments, the fuchsia pigmented fleece can include a mix of the blue pigment having a wavelength between about 400 nm to about 500 nm and a red pigment having a wavelength between about 600 nm to about 700 nm in a ratio of about 1 to about 5, a ratio of about 2 to about 4, a ratio of about 3 to about 3, a ratio of about 4 to about 2, and/or a ratio of about 5 to about 1.

The fleece 100 can include an infrared masterbatch. Some non-limiting examples of the infrared masterbatch can include one or more of silica, silicium, and/or silica mineral particle. An amount of the infrared masterbatch in the fleece 100 can vary. For example, in some embodiments, the amount of infrared masterbatch can be approximately in a range of about 0.2 wt % to about 10 wt %, about 0.5 wt % to about 7 wt %, about 1 wt % to about 6 wt %, about 2 wt % to about 5 wt %, about 3 wt % to about 4.5 wt %, and/or have a value of about 2 wt %, about 3 wt %, and/or about 4 wt % with the wt % being measured relative to a total weight of the fleece. The infrared masterbatch of the fleece 100 can provide greater temperature stability during the night, which can facilitate improved plant growth, as discussed below.

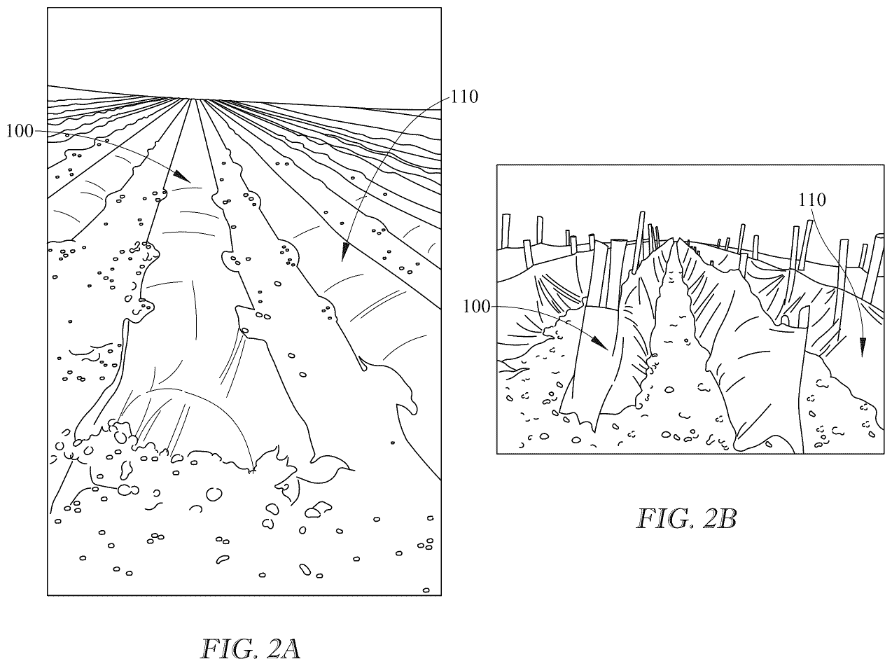

FIGS. 2A-2B illustrates an example embodiment of the fleece 100 used as a row cover next to comparative horticultural fleeces 110. As discussed above, the fleece 100 of the present embodiments can have a blue pigment, e.g., Reflex Blue, and/or PMS 277-303, with specific pigmentation in PMS 286, 293, 2935, as discussed above, that differentiates it from the comparative horticultural fleeces 110, which may be white. The fleece 100 can be used to cover crops that grow in the ground by being laid on top of the soil, as shown in FIG. 2A, or mounted to poles to cover crops that grow raised off the ground, as shown in FIG. 2B.

The fleece 100 of the present embodiments can be used with ground plants, plants, flowers, shrubbery, trees, algae, and the like. Some non-limiting examples of fruits and vegetables that can be tested with the non-woven of the present embodiments can include melons (various Caribbean Gold and Jimbee varieties), watermelon (various Tigris varieties), tomatoes (various Pony express varieties), chili peppers (various Magaly varieties), among other crops. Test results of the various crops and varieties can be found below in the Examples section.

The present embodiments will be further appreciated in light of the following detailed examples, which include testing to assess performance of the fleece 100 with various crops in various geographical locations, e.g., Guatemala, Honduras, and Spain, among others. Assessment of performance was determined by observation and/or measurement of one or more of crop size, overall crop yields or output, number of crops, e.g., fruits, harvested, and/or stress experienced by crops at peak temperatures.

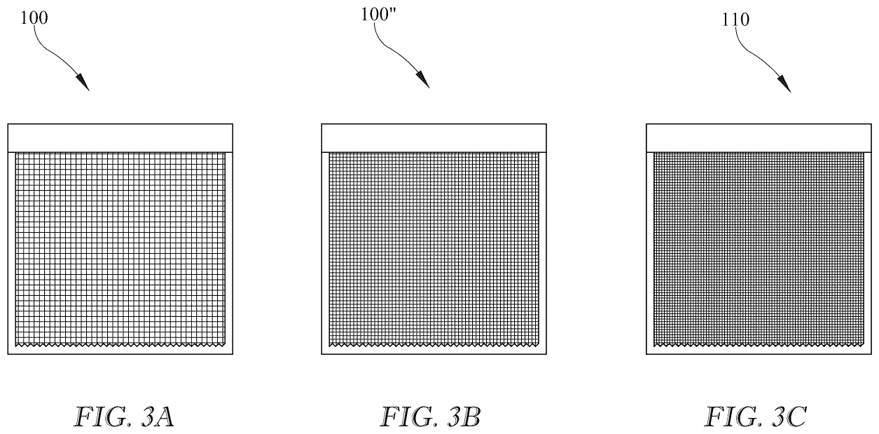

FIGS. 3A-3C illustrate various embodiments of fleece samples 100, 100″, 110 being tested to determine comparative properties thereof. As shown, FIG. 3A includes a sample of the fleece 100 of the present embodiments having a blue pigment and an infrared masterbatch, FIG. 3B includes a sample of a comparative fleece 100″ having the infrared masterbatch but lacking the blue pigment of the fleece 100, and FIG. 3C includes the comparative fleece 110 that lacks both the blue pigment and the infrared (“IR”) masterbatch.

Testing of the fleece 100 with the above-described pigments and the infrared masterbatch for reflectance and transmittance of the non-woven to calculate absorbance (Absorbance=1−% of reflectance−% of transmittance) showed that the blue color and the IR barrier can positively change solar wavelength during the day and/or maintain greenhouse effect during the night. Specifically, the pigmentation of the fleece, e.g., blue and/or fuchsia, was found to positively impact crop growth during the day to change the solar wavelength thereof, while the infrared masterbatch provided improved temperature stability during the night by maintaining said greenhouse effect.

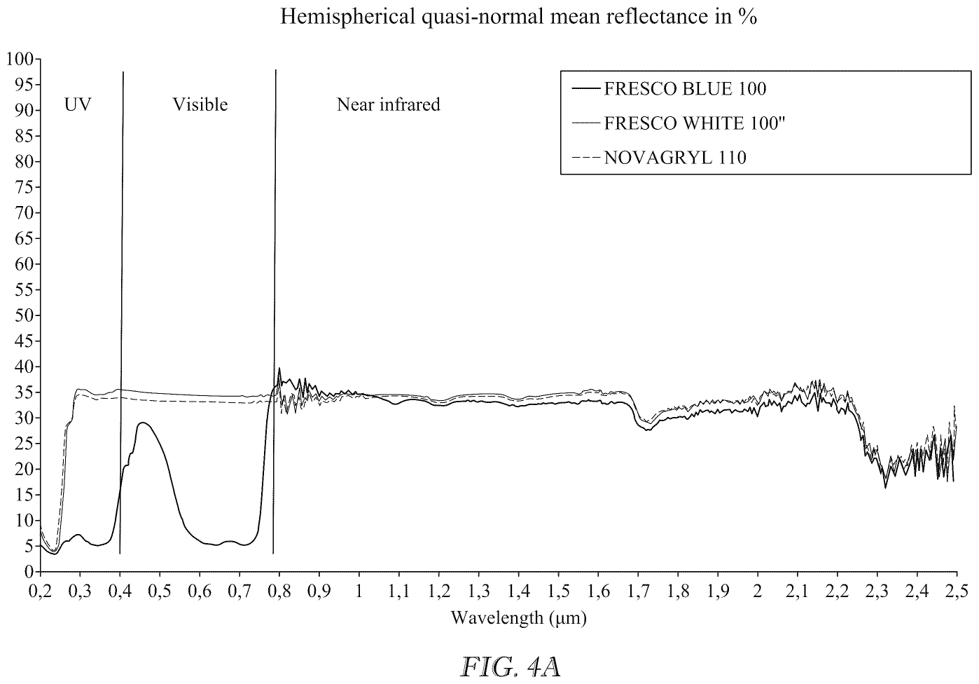

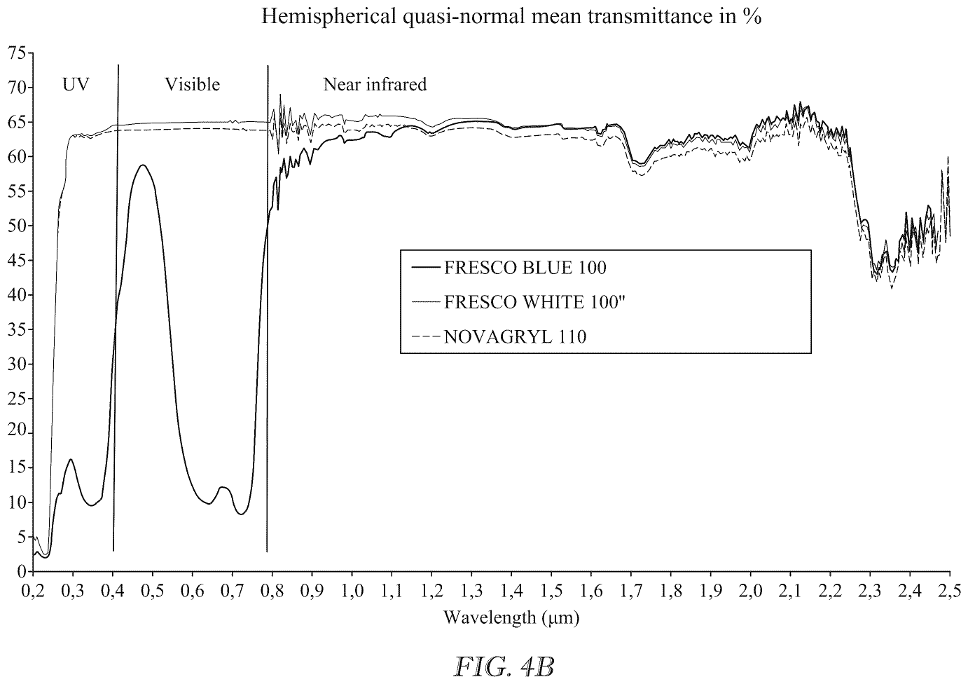

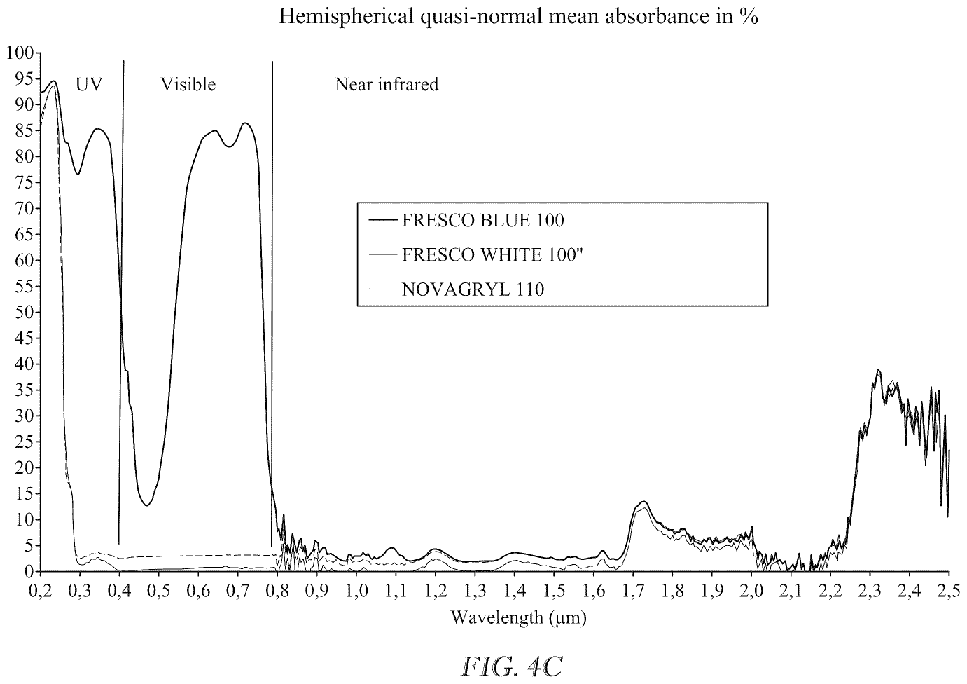

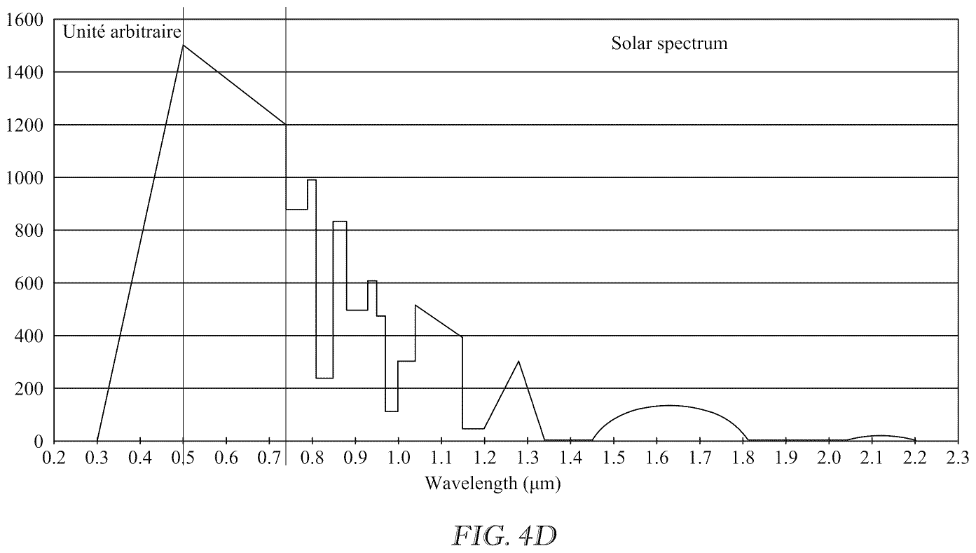

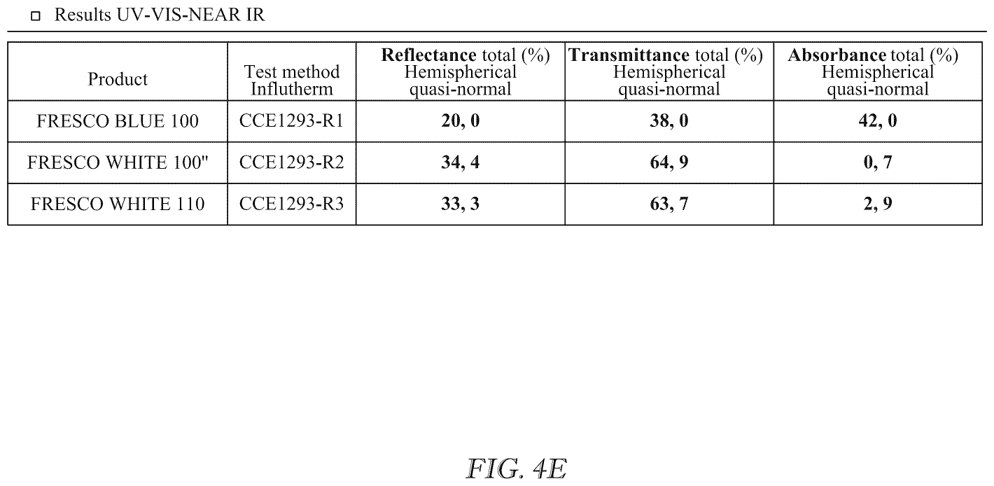

FIGS. 4A-4D illustrate reflectance, transmittance, and absorbance of visible light graphs, respectively, for the fleeces 100, 100″, 110 during the day, while FIG. 4D illustrates a graph of the solar spectrum at this time. As shown, reflectance of the fleece 100 deviates with lower values in the UV and visible wavelengths from comparative fleeces 100″, 110. Moreover, the fleece 100 can have similar values in the infrared spectrum, which suggests that the fleece 100 may be better able to keep the light energy stored in it for use of the plants below. This is confirmed by the graphs of FIGS. 4B and 4C, which shows similar behavior for transmittance and absorbance of UV and visible light as compared to fleeces 100″, 110, with significantly greater absorbance values, of the fleece 100. The blue pigment can therefore modify a quantity of solar energy which is reflected, transmitted and absorbed by the colored fleece during the day. Moreover, reflectance of the fleece 100 is lower, which may suggest that the fleece 100 does not reflect, or minimally reflects, solar energy, while transmitting less solar energy and absorbing about 40% more than the comparative fleece 110, or a fleece that has only infrared masterbatch, e.g., comparative fleece 100″ of FIG. 3B.

A standard graph representing energy given off by the sun is included in FIG. 4D for reference. As shown in FIG. 4D, the graph can illustrate a range of wavelengths when solar energy is strongest (shown between the two bold vertical lines). Moreover, the graph can be integrated to take into account that the energy of the sun may vary based on wavelength and/or can have an impact on solar energy reflected, transmitted and absorbed by the fleeces 100, 100″, 110.

FIG. 4E is a table that tabulates the results of FIGS. 4A-4C. As indicated above, the fleece 100 can have a reflectance that is more than 1.5 times less than comparative horticultural fleece 110, while having a transmittance that is about 2 times less than comparative horticultural fleeces, and an absorbance that is in approximately a range from about 13 times to about 50 times that of comparative horticultural fleeces 110. This suggests that the fleece 100 (or a colored fleece) can modify a quantity of solar energy which is reflected, transmitted or absorbed by the fleece. Moreover, reflectance and transmittance of fleece 100 may be about 60% lower than that of the fleeces without blue masterbatch 100″, 110, while absorbing more solar energy than the fleeces without blue masterbatch 100″, 110. This suggests that during the day, solar energy is less transmitted and more absorbed by the fleece 100 than by comparative fleeces 100″, 110, which limits sunburn of plants, flowers and leaves during growing process. In addition, the fleece 100 can limit visible light that passes therethrough as compared to the non-woven materials, with lower temperatures occurring for crops as compared to comparative horticultural fleece 110 or non-colored fleece.

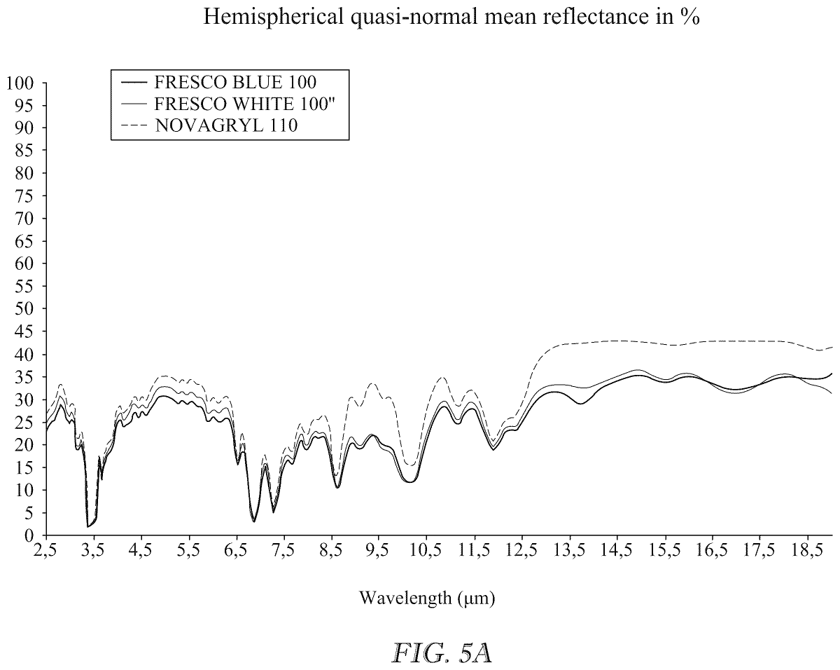

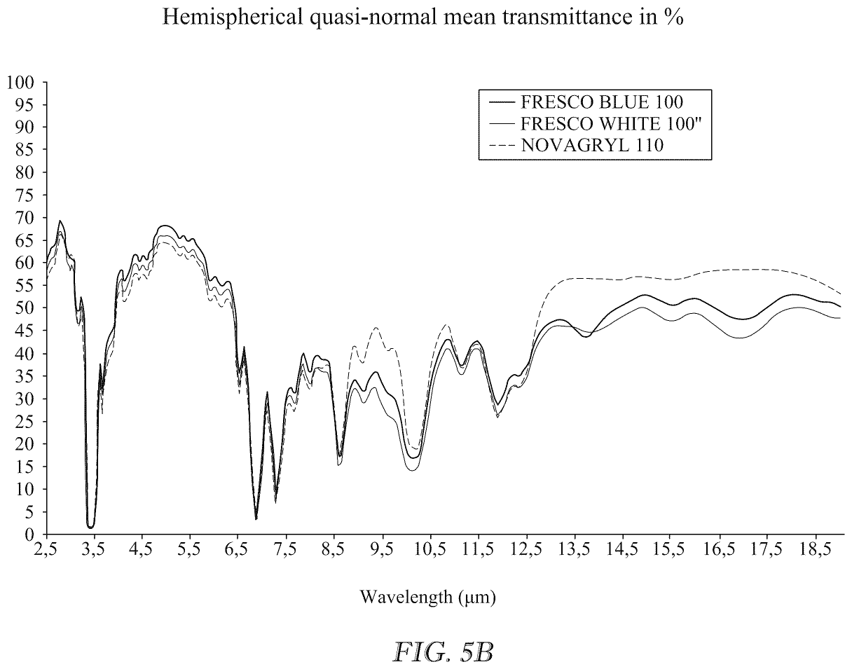

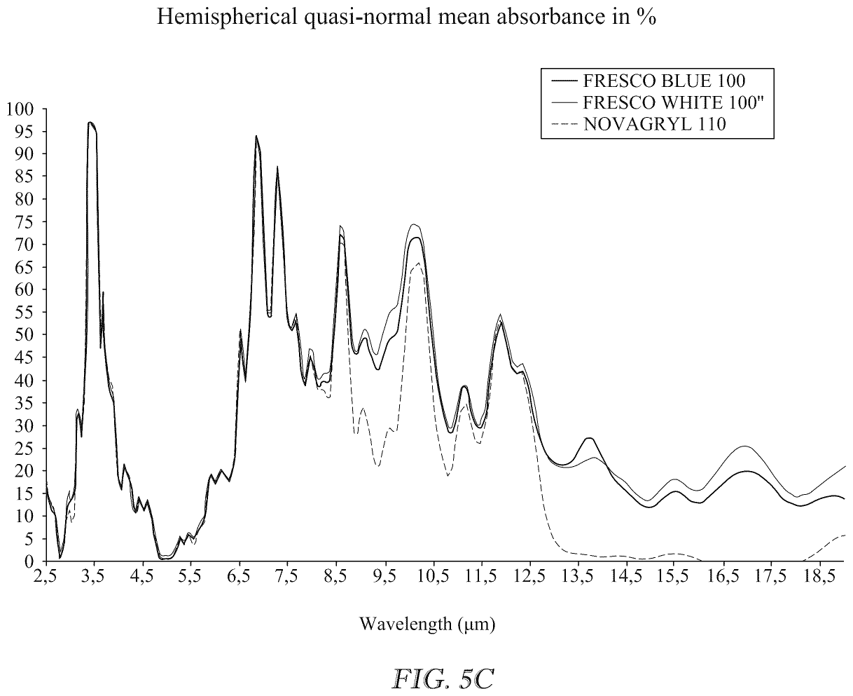

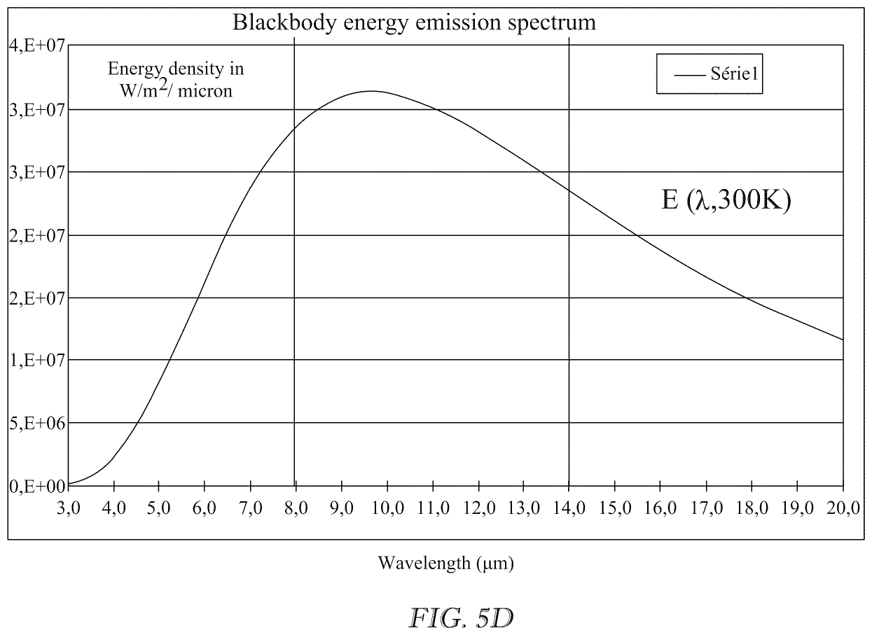

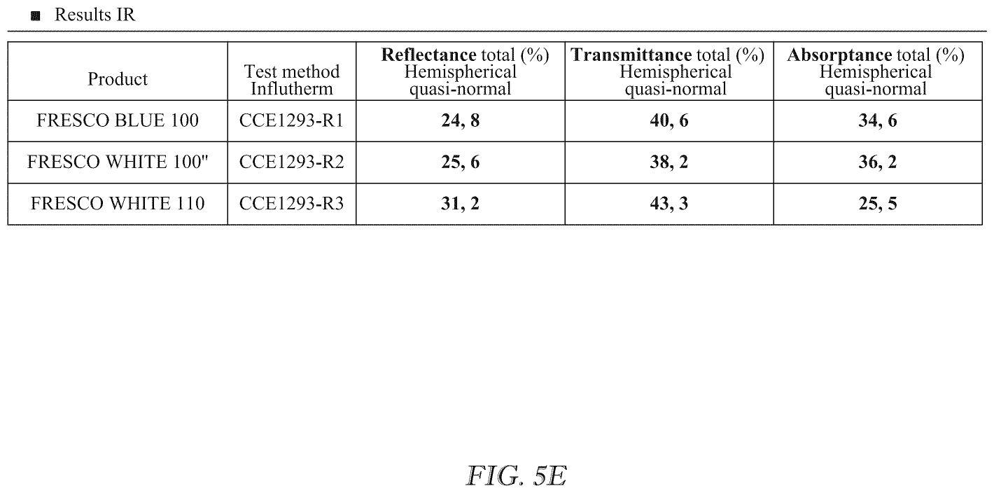

FIGS. 5A-5D illustrate graphs of reflectance, transmittance, and absorbance of blackbody light emission, respectively, for the fleeces 100, 100″, 110 at night, while FIG. 5D illustrates a graph of the blackbody spectrum at this time. As shown, the fleece 100 and the fleece 100″, both of which include IR-barrier masterbatch have a reflectance value and a transmittance value that slightly lower than the comparative fleece 110. Moreover, fleece 100 and fleece 100″ can exhibit deviations in absorbance from that of fleece 110, which may indicate greater absorbance of blackbody emittance than comparative horticultural fleeces. Moreover, as shown in FIG. 5D, the graph can represent energy given off by a blackbody, and show where the blackbody energy is strongest (shown between the two bold vertical lines), which can be integrated to take into account that the energy of the blackbody may vary based on wavelength and/or can have an impact on blackbody energy reflected, transmitted and absorbed by the fleeces 100, 100″, 110.

FIG. 5E is a table that tabulates the results of FIGS. 5A-5C. As indicated above, the fleece 100 and 100″ can have a reflectance and transmittance that are lower than 20% and 10%, respectively, of comparative horticultural fleeces 110, while also having an absorbance that is about 40% more than comparative horticultural fleeces 110. Therefore, the fleeces 100, 100″ having the IR-barrier masterbatch can modify a quantity of blackbody energy which is reflected, transmitted or absorbed by the fleece, which suggests that during the night, where IR-barrier masterbatch is incorporated, a temperature of the soil may be absorbed by the fleeces to create an effect similar to that of the greenhouse effect that keeps the temperature hotter below fleeces 100, 100″, as compared to the comparative fleece 110, promoting increased temperature stability of the crops beneath at night.

### EXAMPLES AND EXPERIMENTATION

The following examples are set forth for purposes of illustration only. Parts and percentages appearing in such examples are approximate unless otherwise stipulated.

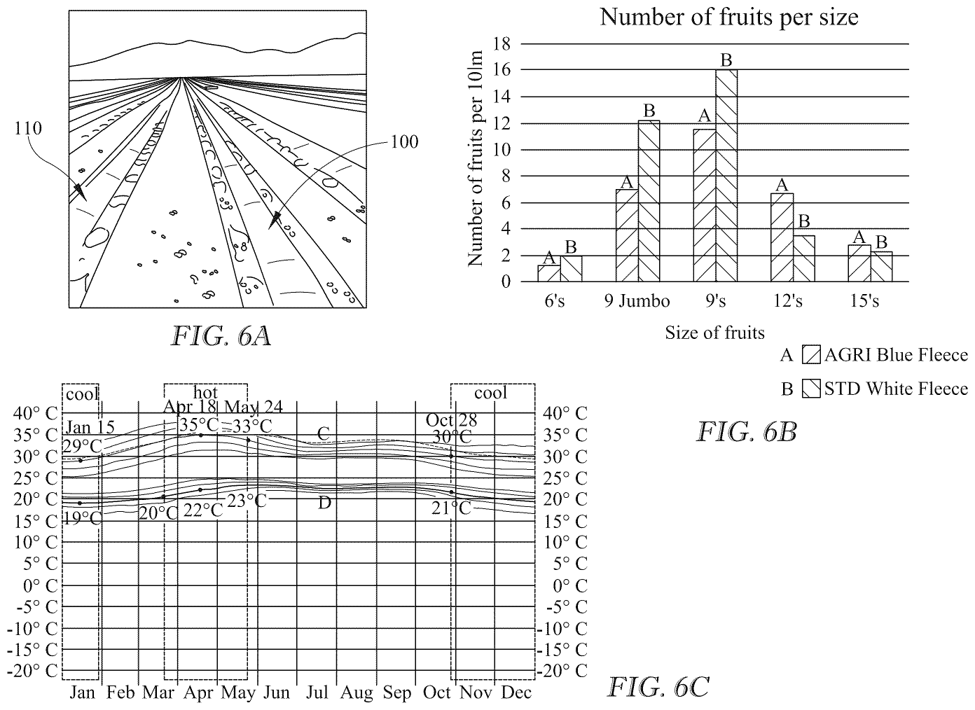

FIGS. 6A-6C illustrate testing of Caribbean gold melon in El Jicaro, Guatemala. FIG. 6A illustrates the fleece 100 used as a row cover next to comparative horticultural fleeces 110. Tests were performed on a field size of approximately 1700 m². Output was evaluated as a number of exportable fruits per ten (10) linear meters counted one day before harvest. Results for comparing output using the fleece 100 versus a comparative horticulture fleeces 110 are shown below:

| | | | % |
|---|---|---|---|
| Parameter | Fleece 100 | Horticulture Fleece 110 | comparison |
| Number of Fruits | 117 | 144 | −19% |
| Fruits/linear meter | 2.9 | 3.6 | −19% |
| Average size | 10.1 | 9.5 | +6% |
| Average weight | N/A | N/A | N/A |
| Gross yields | 1,115 | 1,372 | −19% |

FIG. 6B graphically illustrates a comparison of number of fruits per 10 linear meters versus size of fruits for the fleece 100 (bar A) and the horticulture fleece 110 (bar B). FIG. 6C illustrates a comparison of ambient temperatures (curves C and D) over a year period, with curve C illustrating the high temperature each day and curve D illustrating the low temperature each day. As shown, the low ambient temperatures (curve D) can be about 10 to about 12 degrees Celsius cooler than the high ambient temperatures (curve C).

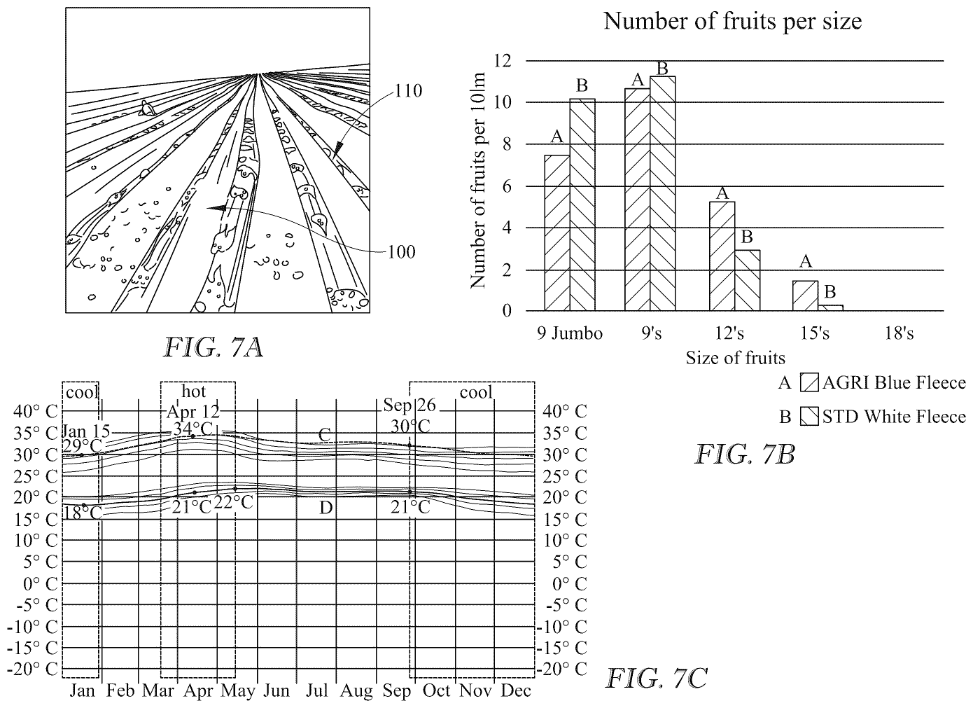

FIGS. 7A-7C illustrate testing of Caribbean gold melon in Asuncion Mita, Guatemala. FIG. 7A illustrates the fleece 100 used as a row cover next to comparative horticultural fleeces 110. Tests were performed on a field size of approximately 865 m². Output was evaluated as a number of exportable fruits per ten (10) linear meters counted one day before harvest. Results for comparing output using the fleece 100 versus a comparative horticulture fleeces 110 are shown below:

| | | | % |
|---|---|---|---|
| Parameter | Fleece 100 | Horticulture Fleece 110 | comparison |
| Number of Fruits | 100 | 99 | +6% |
| Fruits/linear meter | 2.5 | 2.48 | +1% |
| Average size | 10 | 9.4 | +6% |
| Average weight | 3.99 | 4.32 | −8% |
| Gross yields | 2,207 | 2,307 | −5% |

FIG. 7B graphically illustrates a comparison of number of fruits per 10 linear meters versus size of fruits for the fleece 100 (bar A) and the horticulture fleece 110 (bar B). FIG. 7C illustrates a comparison of ambient temperatures (curves C and D) over a year period, with curve C illustrating the high temperature each day and curve D illustrating the low temperature each day. As shown, the low ambient temperatures (curve D) can be about 10 to about 12 degrees Celsius cooler than the high ambient temperatures (curve C).

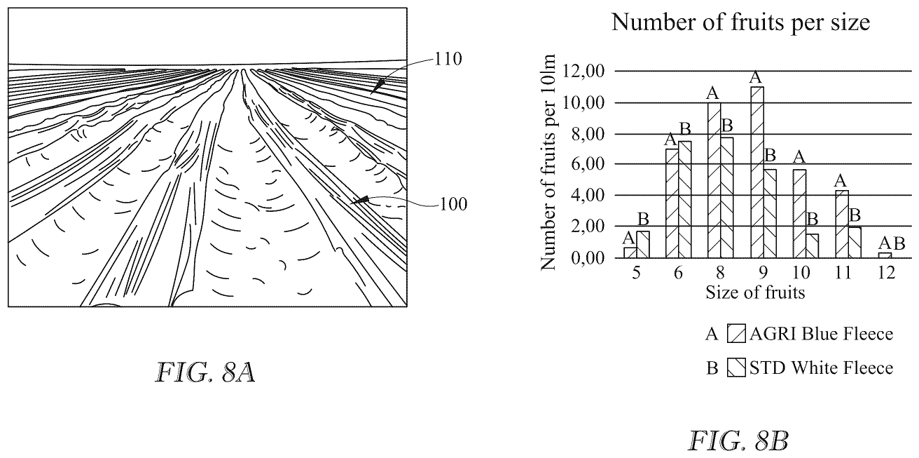

FIGS. 8A-8B illustrate testing of Tigris watermelon in El Jicaro, Guatemala. FIG. 8A illustrates the fleece 100 used as a row cover next to comparative horticultural fleeces 110. Tests were performed on a field size of approximately 2,160 m². Output was evaluated as a number of exportable fruits per ten (10) linear meters counted one day before harvest. Results for comparing output using the fleece 100 versus a comparative horticulture fleeces 110 are shown below:

| | | | % |
|---|---|---|---|
| Parameter | Fleece 100 | Horticulture Fleece 110 | comparison |
| Number of Fruits | 117 | 105 | +11% |
| Fruits/linear meter | 3.9 | 2.6 | +50% |
| Average size | 8.5 | 7.8 | +9% |
| Gross yields | 1,740 | 1,172 | +50% |

FIG. 8B graphically illustrates a comparison of number of fruits per 10 linear meters versus size of fruits for the fleece 100 (bar A) and the horticulture fleece 110 (bar B).

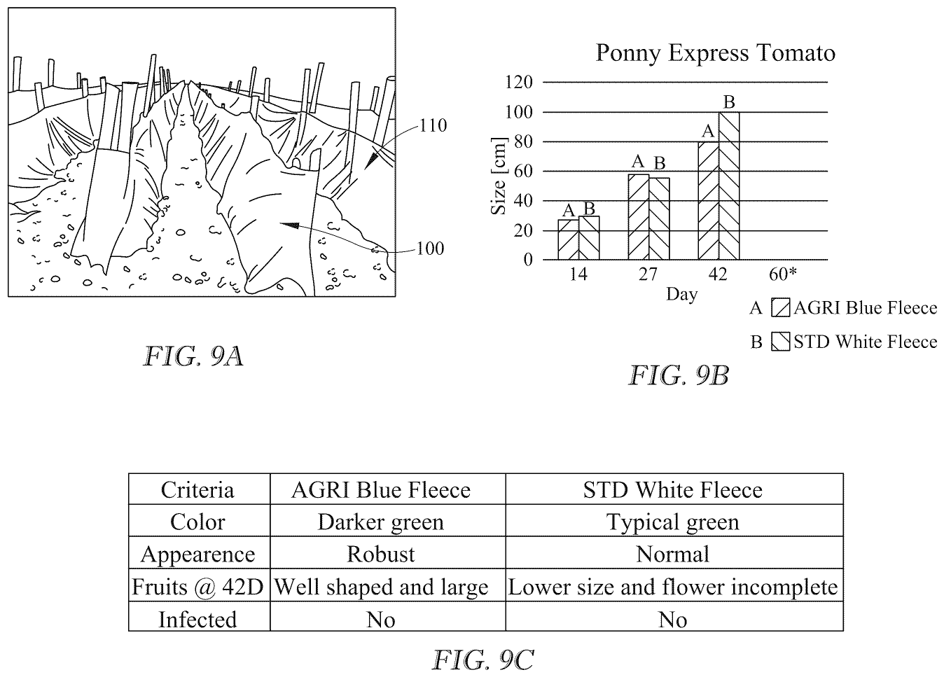

FIGS. 9-9C illustrate testing of Pony Express Tomato in Siguatepeque, Honduras. FIG. 9A illustrates the fleece 100 used as a row cover next to comparative horticultural fleeces 110. Tests were performed on a field size of approximately 640 m². Output was evaluated as a size of the fruits. Results for comparing color, appearance, fruits at 42 days, and infection are shown in FIG. 9C. FIG. 9B graphically illustrates a comparison of size of fruits versus number of days for the fleece 100 (bar A) and the horticulture fleece 110 (bar B).

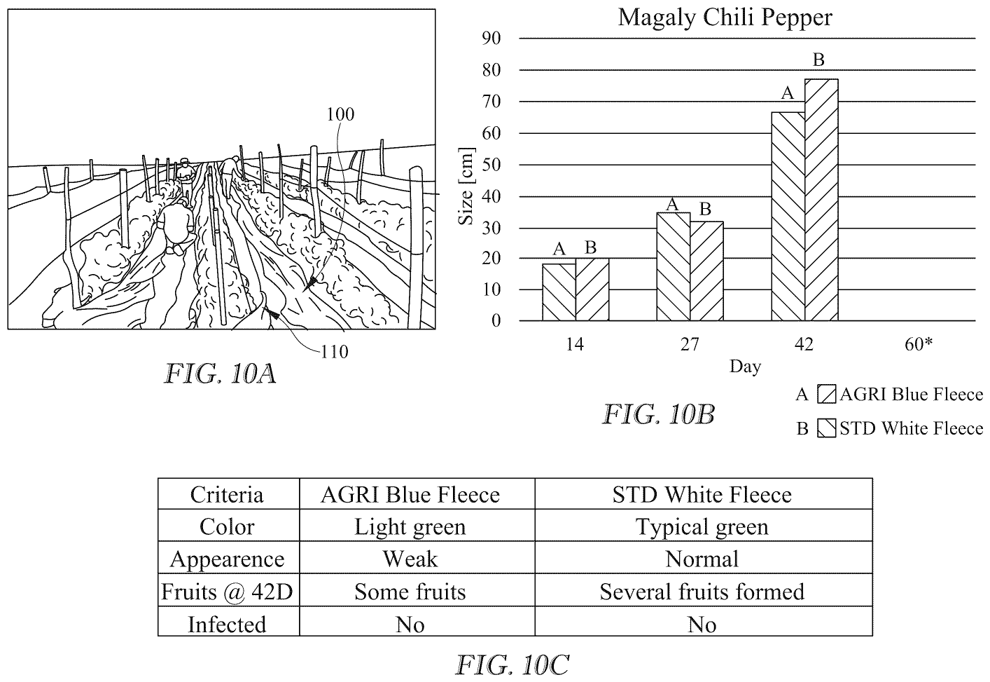

FIGS. 10A-10C illustrate testing of Magaly Chili Pepper in Siguatepeque, Honduras. FIG. 10A illustrates the fleece 100 used as a row cover next to comparative horticultural fleeces 110. Tests were performed on a field size of approximately 640 m². Output was evaluated as a size of the fruits. Results for comparing color, appearance, fruits at 42 days, and infection are shown in FIG. 10C. FIG. 10B graphically illustrates a comparison of size of fruits versus number of days for the fleece 100 (bar A) and the horticulture fleece 110 (bar B).

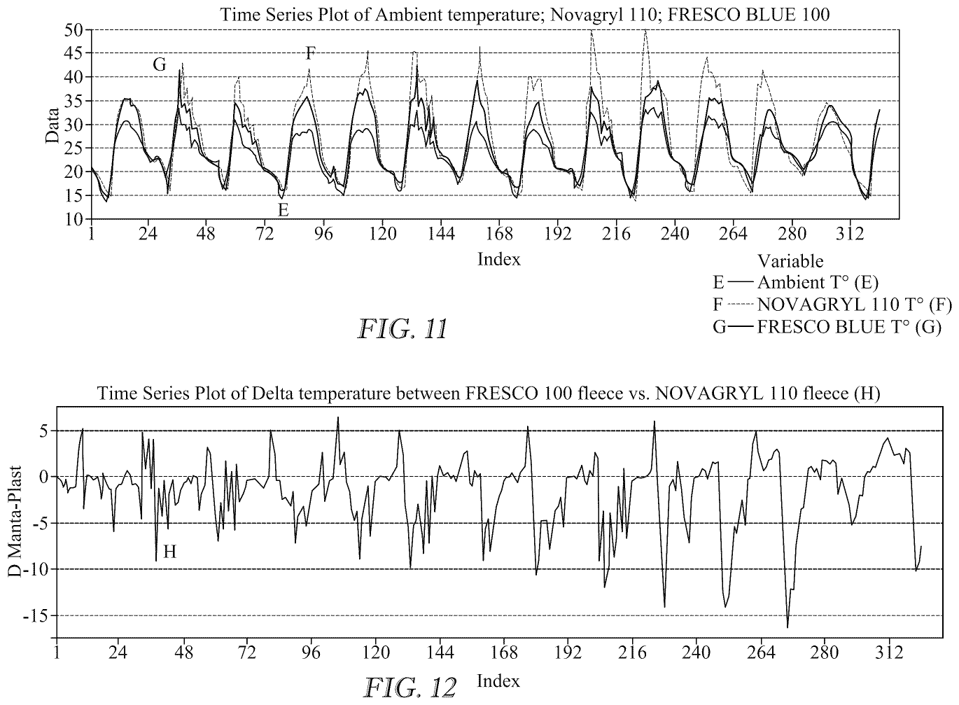

Testing of Jimbee melon in Spain occurred on an unknown field size. Output was evaluated as a temperature below the fleece 100. Results indicate that the temperature under the fleece 100 is in approximately a range of about 10 degrees Celsius to about 20 degrees Celsius lower than ambient temperature, with the temperature being controlled over time, while use of the comparative horticultural fleeces, e.g., comparative horticultural fleeces 110 created a sauna effect. Moreover, crops under the fleece 100 were visually more developed, stronger, and had larger leaves. FIG. 11 illustrates the results of this testing in greater detail. As shown, ambient temperature (curve E), temperature of the crops under the horticulture fleece (curve F), temperature of the crops under the fleece (curve G) are graphed relative to one another to illustrate variation over a two week, e.g., 14 day, period that occurred when the fleece 100 covering the fields after sow until the growth of first flowers. The temperature of the crops under the fleece 100 can be seen to substantially consistently be lower than that of ambient temperature and the temperature under the horticulture fleece. Moreover, the temperature of the crops under the fleece 100 (curve G) exhibited less variation on a daily basis than either of the other curves. Curve H, as shown in FIG. 12, illustrates a delta temperature between the fleece 100 and the comparative horticultural fleeces 110. As shown, at the high peak of the day, a temperature below the fleece 100 can be from about 10° C. to about 20° C. lower than the temperature below the comparative horticultural fleece 110, while, at a low peak of the day, a temperature below the fleece 100 can be up to 5° C. higher than the temperature below the comparative horticultural fleece 110. This suggests that the fleece 100 can exhibit greater control, e.g., less variation, over temperature underneath the fleece between day and night. It will be appreciated melon and watermelon exhibit superior growth in temperatures that range from about 17° C. to about 30°° C. or about 35° C.

Results of the experiments illustrate that use of the fleece 100 improved size and number of fruits harvested and overall crop yields, e.g., Tigris watermelon, fruits exhibited less stress at peak temperatures, e.g., Pony Express Tomato, and/or temperature of the crop was more controlled with less variation in temperature between day and night, e.g., Jimbee melon. In some embodiments, the fleece 100 can be used in combination with black film to lower temperature of the crops, such as with Jimbee melon testing discussed above. Moreover, testing showed that flowers and leaves appeared stronger and/or healthier for the majority of the crops.

The following numbered clauses include embodiments that are contemplated and non-limiting:

Clause 1. An agricultural cover, comprising a non-woven.

Clause 1.1. The agricultural cover of clause 1, any other suitable clause, or any combination of suitable clauses, wherein the one or more non-woven fibers are arranged to form a fleece.

Clause 1.2. The agricultural cover of clause 1, any other suitable clause, or any combination of suitable clauses, wherein the non-woven is formed from a spunbond material.

Clause 3. The agricultural cover of clause 1, any other suitable clause, or any combination of suitable clauses, wherein the non-woven includes pellets of a polymer or a copolymer that is configured to cover crops.

Clause 4. The agricultural cover of clause 3, any other suitable clause, or any combination of suitable clauses, wherein the non-woven causes a temperature of the crops covered thereby to be in a range of about 5 degrees Celsius to about 20 degrees Celsius cooler than ambient temperature.

Clause 5. The agricultural cover of clause 4, any other suitable clause, or any combination of suitable clauses, wherein the non-woven causes a temperature of the crops covered thereby to be in a range of about 5 degrees Celsius to about 20 degrees Celsius cooler than a comparative non-woven.

Clause 6. The agricultural cover of clause 5, any other suitable clause, or any combination of suitable clauses, wherein the non-woven has a blue color.

Clause 7. The agricultural cover of clause 6, any other suitable clause, or any combination of suitable clauses, wherein the blue color is Reflex Blue or PMS 277-303, with specific pigmentation in PMS 286, 293, 2935.

Clause 8. The agricultural cover of clause 4, any other suitable clause, or any combination of suitable clauses, wherein the polymer or copolymer can include one or more of polyethylene terephthalate, polyethylene naphthalate, polytrimethylene terephthalate, polypropylene naphthalate, polybutylene terephthalate, polybutylene naphthalate, polyethylene(terephthalate/isophthalate), polytrimethylene(terephthalate/isophthalate), polybutylene(terephthalate/isophthalate), polyethylene terephthalate-polyethylene glycol, polytrimethylene terephthalate-polyethylene glycol, polybutylene terephthalate-polyethylene glycol, polybutylene naphthalate-polyethylene glycol, polyethylene terephthalate-poly(tetramethylene oxide) glycol, polytrimethylene terephthalate-poly(tetramethylene oxide) glycol, polybutylene terephthalate-poly(tetramethylene oxide) glycol, polybutylene naphthalate -poly(tetramethylene oxide) glycol, polyethylene(terephthalate/isophthalate) -poly(tetramethylene oxide) glycol, polytrimethylene(terephthalate/isophthalate) -poly(tetramethylene oxide) glycol, polybutylene(terephthalate/isophthalate) -poly(tetramethylene oxide) glycol, polybutylene(terephthalate/succinate), polyethylene(terephthalate/succinate), polybutylene(terephthalate/adipate), polyethylene(terephthalate/adipate), polyhydroxyalkanoates (PHA), poly(lactic acid) (PLA), or poly(butylene succinate) (PBS).

Clause 9. The agricultural cover of clause 4, any other suitable clause, or any combination of suitable clauses, wherein an amount of the polymer is approximately in a range of about 70 wt % to about 98 wt %.

Clause 10. The agricultural cover of clause 4, any other suitable clause, or any combination of suitable clauses, further comprising a UV stabilizer.

Clause 11. The agricultural cover of clause 10, any other suitable clause, or any combination of suitable clauses, wherein the UV stabilizer is in an amount approximately in a range of about 0.3 wt % to about 0.6 wt %.

Clause 12. The agricultural cover of clause 11, any other suitable clause, or any combination of suitable clauses, wherein the UV stabilizer comprises a masterbatch with sterically hindered amine.

Clause 13. The agricultural cover of clause 4, any other suitable clause, or any combination of suitable clauses, further comprising a coloring composition containing a pigment dispersion and a crosslinking agent.

Clause 14. The agricultural cover of clause 13, any other suitable clause, or any combination of suitable clauses, wherein the pigment dispersion containing a pigment having an average particle size of 0.1 to 0.5 μm.

Clause 15. The agricultural cover of clause 14, any other suitable clause, or any combination of suitable clauses, wherein the pigment dispersion further comprises a blue masterbatch pigment of Reflex Blue or PMS 277-303, with specific pigmentation in PMS 286, 293, 2935.

Clause 16. The agricultural cover of clause 14, any other suitable clause, or any combination of suitable clauses, further comprising a polymeric dispersant having a hydrophobic group and an ionic group.

Clause 17. The agricultural cover of clause 16, any other suitable clause, or any combination of suitable clauses, further comprising an aqueous medium.

Clause 18. The agricultural cover of clause 14, any other suitable clause, or any combination of suitable clauses, further comprising an infrared masterbatch.

Clause 19. The agricultural cover of clause 18, any other suitable clause, or any combination of suitable clauses, wherein the infrared masterbatch is in an amount approximately in a range of about 2 wt % to about 5 wt %.

Clause 20. The agricultural cover of clause 19, any other suitable clause, or any combination of suitable clauses, wherein the infrared masterbatch further comprises one or more of silica, silicium, or silica mineral particle.

Clause 20.1. The agricultural cover of clause 4, any other suitable clause, or any combination of suitable clauses, wherein the temperature of the crops covered by the non-woven during the day is in the range of about 5 degrees Celsius to about 10 degrees Celsius cooler than ambient temperature.

Clause 20.2. The agricultural cover of clause 4, any other suitable clause, or any combination of suitable clauses, wherein a reflectance of the non-woven during the day is more than 1.5 times less than comparative horticultural fleeces.

Clause 20.3. The agricultural cover of clause 4, any other suitable clause, or any combination of suitable clauses, wherein a transmittance of the fleece during the day is about 2 times less than comparative horticultural non-wovens

Clause 20.4. The agricultural cover of clause 4, any other suitable clause, or any combination of suitable clauses, wherein an absorbance of the non-woven during the day is in approximately a range from about 13 times to about 50 times that of comparative horticultural non-wovens.

Clause 20.5. The agricultural cover of clause 4, any other suitable clause, or any combination of suitable clauses, wherein a reflectance of the non-woven at night is within about 20% of comparative horticultural non-wovens.

Clause 20.6. The agricultural cover of clause 4, any other suitable clause, or any combination of suitable clauses, wherein an absorbance of blackbody emittance of the non-woven at night is greater than that of comparative horticultural non-wovens.

Clause 20.7. The agricultural cover of clause 4, any other suitable clause, or any combination of suitable clauses, wherein the non-woven has a fuchsia color.

Clause 20.8. The agricultural cover of clause 20.7, any other suitable clause, or any combination of suitable clauses, wherein the fuchsia color comprises a combination of a red pigment and a blue pigment in a ratio of about 1 to about 5 to a ratio of about 5 to about 1.

Clause 21. A spunbond non-woven is configured to provide means for normalizing or limiting variability of temperatures of crops disposed under the spunbond fleece as compared to crops exposed to ambient temperatures to improve one or more of crop size, overall crop yields or output, number of crops harvested, or stress experienced by crops at peak temperatures.

Clause 21.1. The spunbond non-woven of clause 21, any other suitable clause, or any combination of suitable clauses, wherein one or more of crop size, overall crop yields or output, number of crops harvested, or stress experienced by crops at peak temperatures is improved relative to a comparative horticultural non-woven.

Clause 22. The spunbond non-woven of clause 21, any other suitable clause, or any combination of suitable clauses, wherein the non-woven causes a temperature of the crops covered thereby to be in a range of about 5 degrees Celsius to about 20 degrees Celsius cooler than a comparative non-woven.

Clause 22.1 The spunbond non-woven of clause 21, any other suitable clause, or any combination of suitable clauses, wherein the non-woven causes a temperature of the crops covered thereby to be in a range of about 5 degrees Celsius to about 20 degrees Celsius cooler than a comparative non-woven.

Clause 23. The spunbond non-woven of clause 21, any other suitable clause, or any combination of suitable clauses, wherein the crops are one or more of ground plants, plants, flowers, shrubbery, trees, or algae.

Clause 24. The spunbond non-woven of clause 21, any other suitable clause, or any combination of suitable clauses, wherein the ground plants further comprise one or more of melons, watermelon, tomatoes, or chili peppers.

Clause 25. The spunbond non-woven of clause 21, any other suitable clause, or any combination of suitable clauses, wherein the ground plant is a Tigris watermelon.

Clause 26. An agricultural cover, comprising a non-woven being formed from a spunbond material that includes pellets of a polymer or a copolymer, the non-woven having a pigment masterbatch and an infrared masterbatch, the pigment masterbatch including one or more of a blue pigment or a red pigment, and the infrared masterbatch in an amount of about 0.2 wt % to about 10 wt %.

Clause 27. The agricultural cover of clause 26, any other suitable clause, or any combination of suitable clauses, wherein the blue pigment is Reflex Blue or PMS 277-303, with specific pigmentation in PMS 286, 293, 2935.

Clause 28. The agricultural cover of clause 26, any other suitable clause, or any combination of suitable clauses, wherein the pigment masterbatch include a combination of the red pigment having a wavelength between about 600 nm to about 700 nm and the blue pigment having a wavelength between about 400 nm to about 500 nm.

1. An agricultural cover, comprising:
a non-woven that includes pellets of a polymer or a copolymer that is configured to cover crops to cause a temperature of the crops covered thereby to be in a range of about 5 degrees Celsius to about 20 degrees Celsius cooler than ambient temperature.

2. The agricultural cover of claim 1, wherein the non-woven causes a temperature of the crops covered thereby to be in a range of about 5 degrees Celsius to about 20 degrees Celsius cooler than a comparative non-woven.

3. The agricultural cover of claim 1, wherein the non-woven has a blue color.

4. The agricultural cover of claim 3, wherein the blue color is Reflex Blue or PMS 277-303, with specific pigmentation in PMS 286, 293, 2935.

5. The agricultural cover of claim 1, wherein the polymer or copolymer can include one or more of polyethylene terephthalate, polyethylene naphthalate, polytrimethylene terephthalate, polypropylene naphthalate, polybutylene terephthalate, polybutylene naphthalate, polyethylene(terephthalate/isophthalate), polytrimethylene(terephthalate/isophthalate), polybutylene(terephthalate/isophthalate), polyethylene terephthalate-polyethylene glycol, polytrimethylene terephthalate-polyethylene glycol, polybutylene terephthalate-polyethylene glycol, polybutylene naphthalate-polyethylene glycol, polyethylene terephthalate-poly(tetramethylene oxide) glycol, polytrimethylene terephthalate-poly(tetramethylene oxide) glycol, polybutylene terephthalate-poly(tetramethylene oxide) glycol, polybutylene naphthalate -poly(tetramethylene oxide) glycol, polyethylene(terephthalate/isophthalate) -poly(tetramethylene oxide) glycol, polytrimethylene(terephthalate/isophthalate) -poly(tetramethylene oxide) glycol, polybutylene(terephthalate/isophthalate) -poly(tetramethylene oxide) glycol, polybutylene(terephthalate/succinate), polyethylene(terephthalate/succinate), polybutylene(terephthalate/adipate), polyethylene(terephthalate/adipate), polyhydroxyalkanoates (PHA), poly(lactic acid) (PLA), or poly(butylene succinate) (PBS).

6. The agricultural cover of claim 1, wherein an amount of the polymer is approximately in a range of about 70 wt % to about 98 wt %.

7. The agricultural cover of claim 1, further comprising a UV stabilizer in an amount approximately in a range of about 0.3 wt % to about 0.6 wt %.

8. The agricultural cover of claim 7, wherein the UV stabilizer comprises a masterbatch with sterically hindered amine.

9. The agricultural cover of claim 1, further comprising a polymeric dispersant having a hydrophobic group and an ionic group, and an aqueous medium.

10. The agricultural cover of claim 1, further comprising an infrared masterbatch in an amount approximately in a range of about 2 wt % to about 5 wt %.

11. The agricultural cover of claim 10, wherein the infrared masterbatch further comprises one or more of silica, silicium, or silica mineral particle.

12. The agricultural cover of claim 1, wherein the temperature of the crops covered by the non-woven during the day is in the range of about 5 degrees Celsius to about 10 degrees Celsius cooler than ambient temperature.

13. The agricultural cover of claim 1, wherein an absorbance of the non-woven during the day is in approximately a range from about 13 times to about 50 times that of comparative horticultural non-wovens.

14. The agricultural cover of claim 1, wherein a reflectance of the non-woven at night is within about 20% of comparative horticultural non-wovens.

15. The agricultural cover of claim 1, wherein the non-woven has a fuchsia color.

16. The agricultural cover of claim 15, wherein the fuchsia color comprises a combination of a red pigment and a blue pigment in a ratio of about 1 to about 5 to a ratio of about 5 to about 1.

17. A spunbond non-woven configured to provide means for normalizing or limiting variability of temperatures of crops disposed under the spunbond non-woven as compared to crops exposed to ambient temperatures to improve one or more of crop size, overall crop yields or output, number of crops harvested, or stress experienced by crops at peak temperatures.

18. The spunbond fleece of claim 17, wherein one or more of crop size, overall crop yields or output, number of crops harvested, or stress experienced by crops at peak temperatures is improved relative to a comparative horticultural non-woven.

19. The spunbond fleece of claim 17, wherein the non-woven is formed from a spunbond material.

20. An agricultural cover, comprising:
a non-woven being formed from a spunbond material that includes pellets of a polymer or a copolymer, the non-woven having a pigment masterbatch and an infrared masterbatch, the pigment masterbatch including one or more of a blue pigment or a red pigment, and the infrared masterbatch in an amount of about 0.2 wt % to about 10 wt %.
